(19) United States
(12) Patent Application Publication
(10) Pub. No.: US 2011/0134209 A1
(43) Pub. Date: Jun. 9, 2011

(54) Virtual Structure

(76) Inventor: Eric Schmidt, Wichita, KS (US)

(21) Appl. No.: 12/960,169

(22) Filed: Dec. 3, 2010

Related U.S. Application Data
(60) Provisional application No. 61/266,796, filed on Dec. 4, 2009.

(51) Int. Cl. H04N 7/00

(52) U.S. Cl. 348/38; 348/36; 348/E07.091

(57) ABSTRACT

Disclosed is a virtual room created by locating cameras on the outside walls of a structure, e.g., a building, and then projecting live video from the cameras onto the inside walls of the structure using projectors. Because of the way the projectors and cameras are oriented, the walls appear to be invisible to a person inside the structure.

### CROSS-REFERENCE TO RELATED APPLICATIONS

This application claims the benefit of U.S. Provisional Application No. 61/266,796 filed Dec. 4, 2009.

### BACKGROUND OF THE INVENTION

1. Field of the Invention

The invention relates generally to methods of providing a virtual ambiance, and in some embodiments, entertainment. Some embodiments relate to the field of creating virtual environments. In some embodiments, the environment created is of a sporting event in real time.

2. Description of the Related Art

As is well known, cameras and projectors have been used extensively in a variety of ways to create numerous different audio visual effects. In some AV arrangements, a camera is used to create a live feed to the projector so that the events from one location can be visualized in another.

On another topic, it is well known to create computer-simulated environments that mimic places in the real world, as well as in imaginary worlds. For example, special video goggles can be used to display computer generated images. Sometimes these arrangements include audio speakers or headphones to provide sound effects which correspond with the recorded video being played. Even some systems include force feedback, e.g., vibrations through a device to simulate an explosion or other event seen on the video.

Sometimes a virtual reality environment involves simulated immersion into a 3D environment. For example, systems exist which place the user in a realistic 3D computer-generated environment.

### SUMMARY

The scope of the invention is to be defined by the claims. In embodiments, the invention can be a system of method where a plurality of video cameras are pointed away from the exterior surfaces of the walls of a structure and a display arrangement is located on the interior surfaces of the walls. The display arrangement is arranged to receive live images from the cameras and then display the images to make at least substantial sections of the walls appear to be invisible. In embodiments, the structure is a room.

In some embodiments, the cameras are mounted at and point outward from a center location at an event, and the the display arrangement is adapted to display the live images onto the interior surfaces of the walls such that a person in the room is under the illusion that the person is looking out from the center location at events as they occur. In some embodiments a plurality of microphones are pointed out from the center location at the event to record sound from different directions and a plurality of speakers installed in the structure and pointed in an inward direction to simulate the sounds coming inward as received into the microphones from different directions.

The display arrangement can include a plurality of outwardly facing projectors which display images onto the internal surfaces of the structure.

### BRIEF DESCRIPTION OF THE SEVERAL VIEWS OF THE DRAWINGS

Illustrative embodiments of the present invention are described in detail below with reference to the attached drawing figures, which are incorporated by reference herein and wherein:

FIG. 1 is an illustration of how a virtual effect is created using a camera and projector on each side of a wall;

FIG. 2 shows a four-wall room in which embodiments of the disclosed systems and methods might be executed;

FIG. 3 shows an embodiment for a camera which might be used with the projection arrangement shown in the FIG. 2 embodiment;

FIG. 4 shows an alternative four-wall embodiment;

FIG. 5 shows a nonplanar-walled room in which embodiments of the disclosed systems and methods might be executed;

FIG. 6 shows an embodiment for a camera which might be used with the projection arrangement shown in the FIG. 5 embodiment;

FIG. 7 shows an alternative embodiment where the walls are nonplanar; and

FIG. 8 shows an environment in which the camera arrangements of FIGS. 3 and 6 might be located to create an effect inside of a room.

### DETAILED DESCRIPTION

Embodiments of the present invention provide systems and a method for creating an indoor virtual environment by using one or more cameras positioned in an outside or other desirable remote environment. Given an internal wall in a building or other similar structure, a video camera is provided at a desired position in the outside environment so to capture a desired view. On the inside surface of the wall, a real-time image is created displayed in a way that gives a person inside the building the illusion that the walls do not exist.

Using the principles disclosed herein, the internal walls of a walled structure, e.g., barn, room, restaurant dining area, could display images showing the view you would see as if the walls of the structure are not there. In some embodiments these images could be projected on the inside walls. In others, the walls could be clad with large screen TV's adapted to receive the images received into the cameras.

The video cameras could be located at a position immediately outside of the structure. For example, each camera could be positioned to face out from the outside surface of a wall and receive live video, streamed to a projector (or video monitor) so that the live video received is displayed live on the inside of that same wall. Thus, a person standing inside the structure will not see the walls, but instead the real-time images created. This gives them the illusion that the walls do not exist, and that he or she is outside and able to see all activity on the exterior of the building, e.g., a raging thunderstorm approaching, golden waves of prairie grass.

In other embodiments, the images created could come from an array of remotely mounted cameras, each camera in the array receiving 360 degree images from a desirable location. For example, four cameras mounted in a clocked arrangement from a vantage point in Paris can be used to display images on the four interior walls in a room of a restaurant located in Wichita, Ks. Using this principle, a Wichita diner can be connected into a virtual environment anywhere in the world by locating a camera arrangement in that location.

In embodiments the cameras receive images from clocked positions enabling the display of a 360 degrees image on the internal walls.

The effect could also include an audio component. For example, each camera could include a similarly oriented microphone. Speakers associated with these microphones could be directed outward from the walls in the room from the direction from where the sound-originating things exist in the images being displayed. Thus, not only are the real-time images displayed inside the room to create a virtual effect, but the sounds come to a person in the room as they would to a person in the actual environment. This enables a complete audio/visual effect which is directionally accurate.

These systems enables attendance possibilities where none existed before. The building into which the real-time virtual reality sounds and projections are made could be, e.g., for dining, receptions, and special events. Also, multiple rooms in a common structure could each have a different theme created by images received from a different remote location.

Regarding special events, such as automobile racing, the center field could have cameras mounted radially with six cameras clocked such that they have lenses which are at 60 degrees to one another, totaling 360 degrees. The cameras would receive video images which would be projected by mating projectors onto the interior walls of a remote structure. This gives a person in that structure, e.g., room, any view of the race he or she chooses by looking at any particular wall view. This system could also have 6 mated microphones and speakers, each aimed corresponding to each of the 6 mated cameras and speakers.

Further, new camera techniques have been used for sporting events (e.g., NFL broadcasts) which would enable these same technologies to be used in a new way to view that event. For example, a cable suspended camera would allow an on-field perspective, placing the viewer in the middle of the action. Images received from a 360 degree camera at a golfing event would give the patron at a remotely equipped room a particularly live feel, e.g., standing amidst the spectators, hearing the banter of the fans at the event—even the shushing. Weddings, inaugurations, etc., could be remotely participated in ways never before possible.

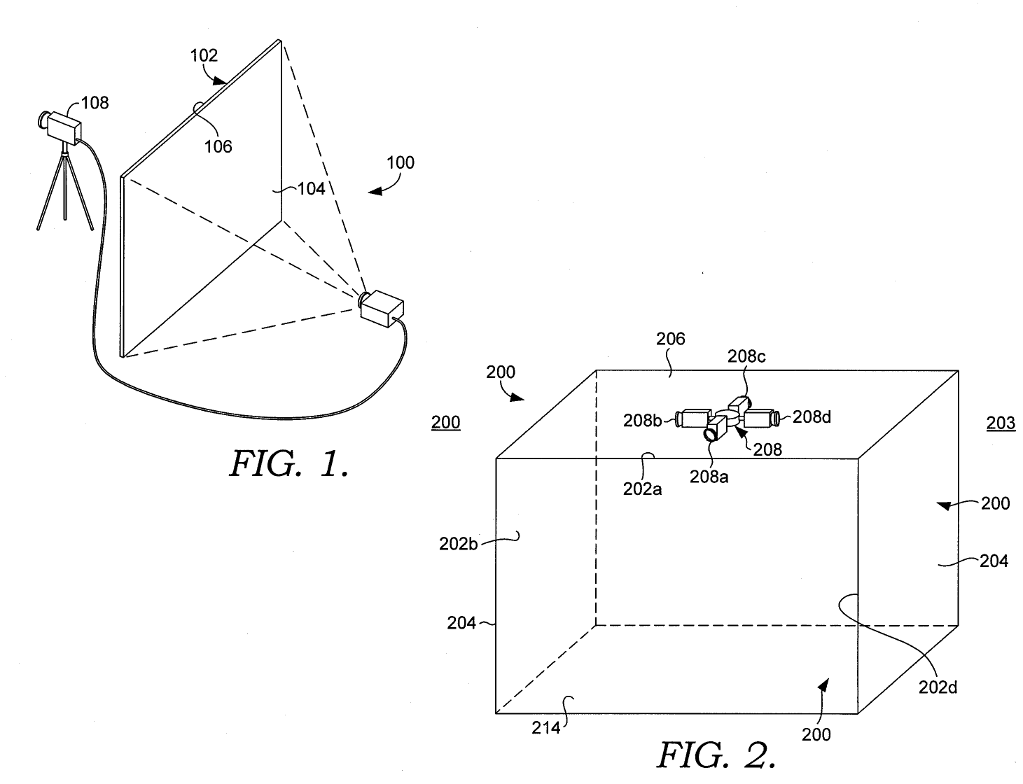

FIG. 1 shows a general arrangement in which a wall can be made to be substantially invisible. Referring to the Figure, it can be seen that the system 100 includes a wall 102. Wall 102 has an inside surface 104 and an outside surface 106. Located outside wall 102, a projector 110 is and made to be in communications with a camera 108 by an electrical connection 112 or some wireless equivalent. Camera 108 is oriented such that it will project against inside surface 104 of wall 102. Camera 108 is directed outwards from the outer surface 106 of wall 102 and is aligned with projector 110 in its vantage point and in the direction it is receiving video from. In other words, the images presented by projector 110 will be aligned with what is seen by camera 108 outside of wall 102. This creates an effect where someone standing on the same side of wall 102 as the projector 110 will see a real-time image of what is outside of the building in the same line of sight they are looking in. Thus, wall 102 is made invisible, and the person feels as if they are currently existing in the outside environment.

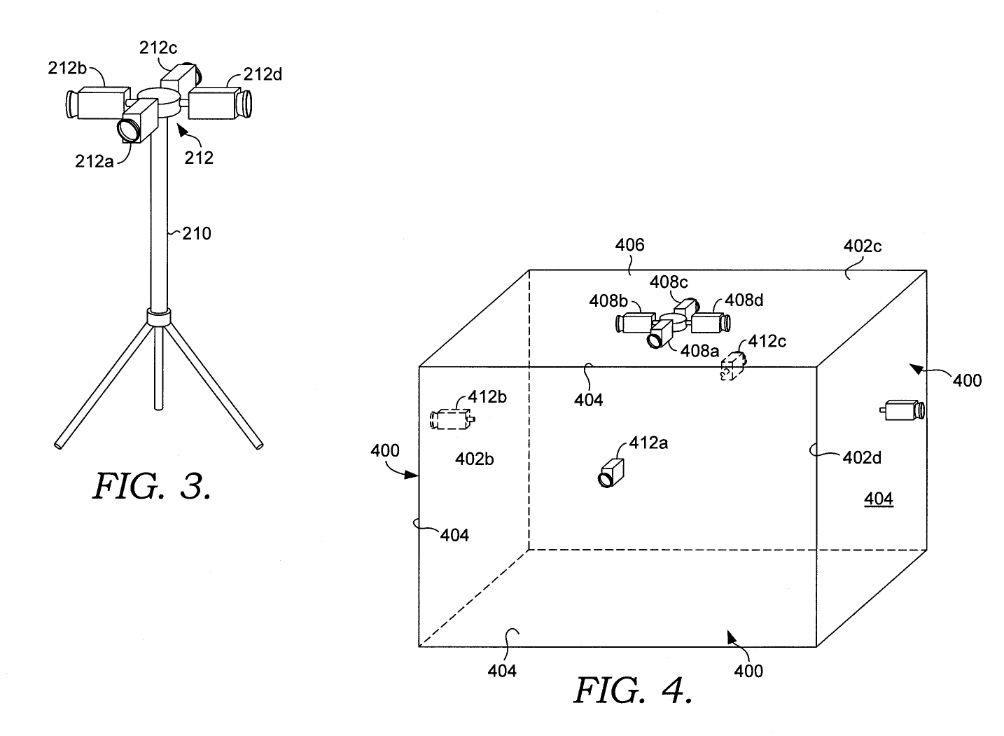

Many different embodiments are possible. For example, an embodiment shown in FIGS. 2 and 3 enables a 360° effect created inside a standard room having four planar vertical walls using real time images received from remotely positioned cameras.

Referring first to FIG. 2, it can be seen that a room includes a plurality of walls 200. Each wall in the plurality of walls 200 has an inside surface 202. The walls 200 shield persons inside the structure from the outside environment 203. Each of walls 200 also has an outside surface 204. The top of the structure is enclosed by a ceiling 206.

It can be seen that a plurality of projectors 208 are suspended from a center point on the ceiling 206. Each of these four projectors 208a, 208b, 208c, and 208d, are directed at respective wall inside surfaces 202a, 202b, 202c, and 202d, respectively. More specifically, each camera is directed towards a particular inside surface of a respective wall. In this embodiment the cameras are pointed slightly downwards since they are overhead, but those skilled in the art will recognize that the positioning, and thus, angling, could be varied depending on the particular application.

Each of the four projectors 208a, 208b, 208c, and 208d are fed by a respective camera 212a, 212b, 212c, and 212d, respectively. In the FIG. 3 embodiment, cameras 212a, 212b, 212c, and 212d are elevated on a tripod camera stand 210. A total of four cameras 212 are shown on the disclosed embodiment (see FIG. 3). Also evident from FIG. 3 is that each camera is at 90° to the camera adjacent thereto. Also, each camera may be angled upward, downward, or substantially level depending on the ideal frame of reference for visualizing surrounding events (or simply the environment). The real-time (or alternatively, recorded) images received from the cameras will enable the creation of a real-time effect in the room of FIG. 2.

A person standing on floor 214 in room 200 will see projections on each of wall inside surfaces 202a, 202b, 202c, and 202d giving that person the sensation that they are in the remote environment surrounding the cameras 212a, 212b, 212c, and 212d, and that none of the walls 200 exist.

FIG. 4 shows an alternative embodiment wherein a plurality of walls 400 create an enclosure which has inside surfaces 402a, 402b, 402c, and 402d of the structure. Each of inside surfaces 402a, 402b, 402c, and 402d receives an image displayed by a projection device 408a, 408b, 408c, and 408d, respectively. Each of projection devices 408a, 408b, 408c, and 408d receives images from one of cameras 412a, 412b, 412c, and 412d, respectively. The structure protects against the outside environment 403. Walls 400 are enclosed at the top by a ceiling 406 from which the four projectors 408a, 408b, 408c, and 408d are suspended and clocked at 90 degrees to one another. Projectors 408a, 408b, 408c, and 408d will can be pointed slightly downwards so that a viewing area is created on each of inside surfaces 402a, 402b, 402c, and 402d making the user feel as if he or she is actually in the outside environment 403.

Cameras 412a, 412b, 412c, and 412d are mounted on the outsides of each wall. In the FIG. 4 embodiment, they are located at an elevated position. The video cameras 412a, 412b, 412c, and 412d are directed such that projections made by each will be made onto the respective inside surfaces 402a, 402b, 402c, and 402d inside structure 400 in real time. This creates a virtual, real-time effect because each camera receiving video content is on the outside surface of the same wall in which the projections from that camera are made. The projections made onto the inside surfaces of the structure walls create the effect that the walls 400 are invisible. Thus, the person inside the structure on floor 414 is under the illusion that they are in the outside environment when actually they are in an enclosure, and when a real time vision appears behind a particular wall, the person inside the building will see that vision in the same line of sight as would have been seen had the wall not been there.

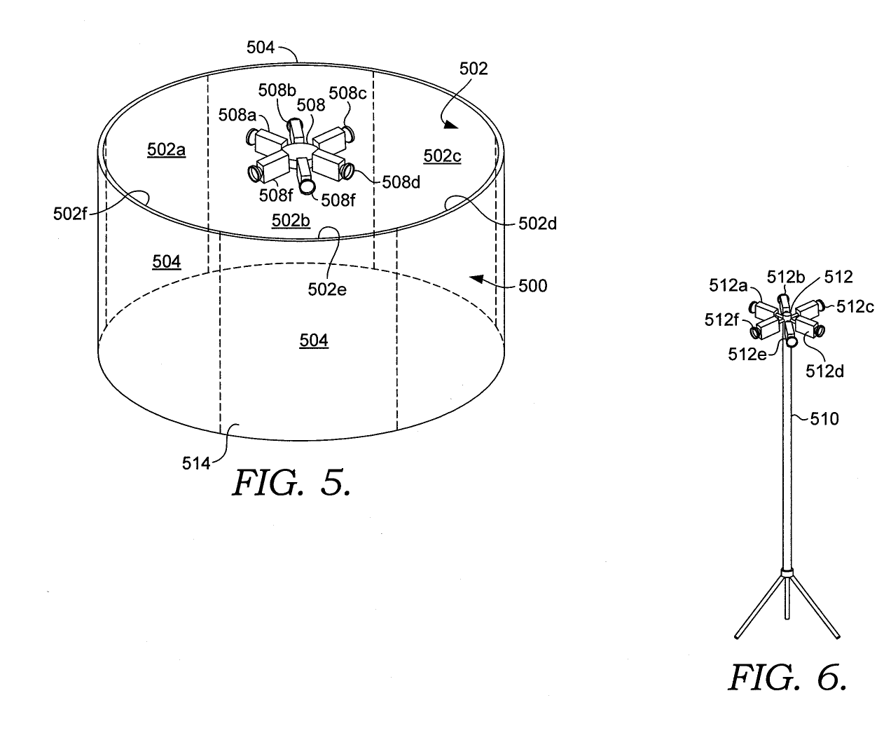

FIGS. 5 through 6 disclose yet another embodiment in which there are no flat walls. Referring first to FIG. 5, it can be seen that a structure with a cylindrical wall 500 is provided which presents an interior wall surface 502. Interior wall surface 502 is broken out into six partitioned inside wall surfaces 502a, 502b, 502c, 502d, 502e, and 502f which will receive different projected images. Wall 500 also has an outside surface 504. In the middle of room 500 suspended from a ceiling 506 is an array of six video projectors 508a, 508b, 508c, 508d, 508e, and 508f. Projectors 508a, 508b, 508c, 508d, 508e, and 508f are clocked at 60 degrees from one another and suspended from the ceiling as shown. Each of projectors 508a, 508b, 508c, 508d, 508e, and 508f display an image onto a particular wall inside surface 502a, 502b, 502c, 502d, 502e, and 502f. Thus, six different projection areas are created within room 500.

FIG. 6 shows a camera stand 510 which could be used with the room of FIG. 5. Stand 510 supports a plurality of cameras 512a, 512b, 512c, 512d, 512e, and 512f. Each camera is clocked 60 degrees relative to the camera next to it. This creates six separate views, which will enable the transfer of a 360 degree image be displayed inside the room of FIG. 5. When the video content received into cameras 512a, 512b, 512c, 512d, 512e, and 512f is projected by projectors 508a, 508b, 508c, 508d, 508e, and 508f (respectively) onto inside surface 502a, 502b, 502c, 502d, 502e, and 502f (respectively) the result is a real-time virtual effect created inside room 500. Regardless of where a person in room 500 looks, they will have the sense that they are actually in the remote location at which stand 510 is located.

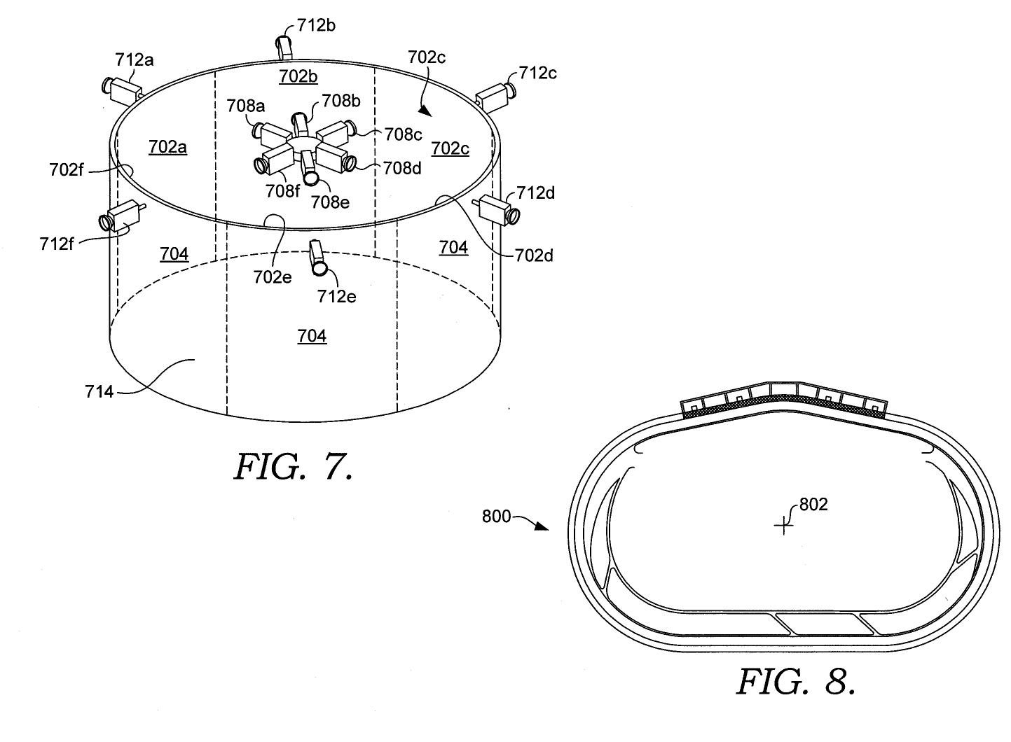

FIG. 7 shows yet another embodiment in which a room defined by a wall 702 has an inside surface broken out into six separate sections 702a, 702b, 702c, 702d, 702e, and 702f. Wall 702 also has an outside surface 704 which includes a plurality of cameras 712a, 712b, 712c, 712d, 712e, and 712f, which will receive images from an array of projectors 708a, 708b, 708c, 708d, 708e, and 708f (respectively) and project these separate six images onto inside surfaces 702a, 702b, 702c, 702d, 702e, and 702f (respectively). The projectors, in embodiments, are suspended from the ceiling of the room defined by wall 702.

It should be understood that in any of the embodiments disclosed in FIGS. 1-7, that video monitors (e.g., LCD displays) would be mounted onto or comprising the walls could be used instead of the projector arrangements.

FIG. 8 shows an environment 800 in which a camera arrangement like that disclosed in FIG. 6 might be incorporated to create a live sporting event feel in a remote room somewhere. More specifically, environment 800 as disclosed is a racetrack for motor vehicles. Racetrack 800 could easily be some other environment such as a football stadium, horseracing track, or numerous other locations. Also noted in FIG. 8 is a central location 802 at which a stand like that shown in FIG. 6 could be located in order to record a live sporting event, for example, a car race.

It should also be noted that along with each of the video cameras, e.g., camera 108, cameras 212a-d, 512a-f, or 708a-f, microphones (not shown) could be associated therewith which are aimed and/or placed to receive audio into the location of each of the mating cameras. (Many cameras come with this audio ability already installed). These microphones would enable the listening to the sounds coming towards the relevant camera. And when used in the room embodiments of in three dimensions, much like the video arrangement provides. Along with each of these microphones, there could be an electrical or wireless connection made to a reciprocating speaker in each of the rooms such that the sound (along with the video) is broadcast internally in the room from a direction and at a volume as would be experienced by a participant at an event (with respect to the FIG. 2 and FIG. 5 embodiments) or as if the walls did not impede the sound (in the FIG. 4 and FIG. 7 embodiments). These speakers (not shown) could be located at various positions in the room. But in one embodiment, they would be located in the walls.

In the remote virtual room embodiments of FIG. 2, the audio content received into the microphones on or about cameras 212a, 212b, 212c, and 212d, would be broadcast inward from speakers mounted in or on walls 202a, 202b, 202c, and 202d, respectively. In the remote virtual room embodiment of FIG. 5, the audio content received into the microphones on or about cameras 512a, 512b, 512c, 512d, 512e, and 512f, would be broadcast inward from speakers mounted in or on wall surfaces 502a, 502b, 502c, 502d, 502e, and 502f (respectively). These audio arrangements complete the 360 degree virtual environment by causing the sounds to be heard inside the room from the same direction they would be relative to the video content being projected. For example, assuming the remote event is a car race, the roaring of a particular car engine will be heard from the same direction in which the car is seen on the inside surfaces of the room.

For the invisible wall arrangements of FIGS. 4 and 7, the speakers would be located to broadcast from the inside surface of the wall on which the microphone/camera arrangement is located. For example, the microphones located proximate cameras 412a, 412b, 412c, and 412d would be used to receive audio for broadcast by speakers located in or on inside surfaces 402a, 402b, 402c, and 402d, respectively. Similarly, the microphones located proximate cameras 712a, 712b, 712c, 712d, 712e, and 712f would be used to receive audio for broadcast by speakers located in or on inside surfaces 702a, 702b, 702c, 702d, 702e, and 702f, respectively. Thus, the sound appears to be coming from the direction in which things are seen outside the building, but the walls do not block it out.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

The invention claimed is:

1. A system comprising:
a structure;
one or more video cameras arranged to receive video imagery from substantially 360 degrees, said one or more video cameras located remotely from said structure; and
a display arrangement inside said structure for receiving said video imagery from said one or more video cameras and displaying said imagery in real time onto opposing internal surfaces in said structure to create a virtual effect.

2. The system of claim 1 wherein the cameras are mounted at and point outward from a center location at an event, the display arrangement adapted to display the live images onto the interior surfaces of the walls such that a person in the room is under the illusion that the person is looking out from the center location at events as they occur.

3. The system of claim 2 comprising:
a plurality of microphones pointed out from the center location at the event to record sound from different directions; and
a plurality of speakers installed in the structure and pointed in an inward direction to simulate the sounds coming inward as received into the microphones from different directions.

4. The system of claim 3 wherein the event is an auto race.

5. The system of claim 4 wherein the event is a sporting event.

6. The system of claim 4 wherein the display arrangement comprises a plurality of outwardly facing projectors which display images onto the internal surfaces of the structure.

7. A system comprising:
a plurality of video cameras pointed away from an exterior surfaces of the walls of a structure;
a display arrangement located on an interior surfaces of the walls, the display arranged to receive live images from the cameras and then display the images on the display arrangement to make at least substantial sections of the walls appear to be invisible.

8. The system of claim 7 wherein the structure is a room.

9. The system of claim 8 wherein the room is in a restaurant.

10. The system of claim 7 comprising:
a plurality of microphones pointed out from the exterior walls of the structure to receive sound from different directions; and
a plurality of speakers installed in the structure and pointed in an inward direction to broadcast the sounds coming inward as received into the microphones from different directions in a way that simulates the sounds received as if the walls were not an obstruction.

11. The system of claim 7 wherein the display arrangement comprises a plurality of outwardly facing projectors which display images onto the internal surfaces of the structure.

12. A method comprising:
mounting video cameras in directions pointing away from a reference location; and
displaying the live video images received from the video cameras on a plurality of interior wall surfaces of a habitable structure.

13. The method of claim 12 comprising:
selecting the habitable structure as the reference location; and
mounting the cameras such that they point away from a plurality of outside surfaces on a plurality of walls of the structure such that the live video images displayed on the interior wall surfaces of the habitable structure create an effect that the walls are invisible.

14. The method of claim 12 comprising:
selecting a remotely-located structure as the reference location; and
mounting the cameras such that they point away from substantially all sides of the remotely-located structure.

15. The method of claim 14 comprising:
making both the habitable structure and the remotely-located structure restaraunts and the video received into one is displayed in the other.
